(19) United States
(12) Patent Application Publication
(10) Pub. No.: US 2024/0270605 A1
(43) Pub. Date: Aug. 15, 2024

(54) FILTRATION DEVICE FOR A WATER-CONDUCTING HOUSEHOLD APPLIANCE

(71) Applicant: emz-Hanauer GmbH & Co. KGaA, Nabburg (DE)

(72) Inventors: GEORG SPIEßL, Altendorf (DE); MANFREDI SIGNORINO, Wackersdorf (DE); BENJAMIN SCHEMELA, Schwarzenbach (DE)

(21) Appl. No.: 18/441,100

(22) Filed: Feb. 14, 2024

(30) Foreign Application Priority Data
Feb. 14, 2023 (DE) 102023103574.6

(51) Int. Cl. C02F 1/00; C02F 101/10

(52) U.S. Cl. CPC C02F 1/003; C02F 2101/10; C02F 2209/445

(57) ABSTRACT

The invention relates to a filtration device, in particular for the filtration of microplastics for a water-carrying household appliance, wherein the filtration device comprises a housing in which a first filter element is arranged, wherein the first filter element is designed in such a manner that it encloses an inner cavity which is fluidly connected to a first discharge element, wherein between the first filter element and the housing there is an intermediate space into which the water to be filtered can be introduced, wherein a second filter element is provided between the intermediate space and a second discharge element.

### CROSS-REFERENCE TO RELATED APPLICATION(S)

This patent application claims the benefit of and priority to German Patent Application No. 102023103574.6, filed on Feb. 14, 2023, which is herein incorporated by reference in its entirety.

### FIELD OF THE DISCLOSURE

The invention relates to a filtration device, in particular for the filtration of microplastics for a water-carrying household appliance, wherein the filtration device comprises a housing. The invention also relates to a water-carrying household appliance with a filtration device, in particular for filtering microplastics.

### BACKGROUND

Microplastics are solid, insoluble, particle-based and non-biodegradable synthetic substances or plastics. The microplastic particles have a size in the micrometer or nanometer range. Microplastic are components in detergents, soaps, etc.

### SUMMARY

When washing synthetic textiles or garments containing synthetic textile components, the smallest synthetic fibers are dissolved. The unfiltered microplastic particles and fibers have a significant harmful impact on aquatic flora and fauna and therefore also on humans as part of the food chain. Water-conducting household appliances are therefore equipped with filter devices. However, these are often not able to effectively remove the microplastic particles and fibers. More effective filters, on the other hand, have the disadvantage that they clog quickly and therefore require considerable maintenance.

The object of the invention is to provide an improved filtration system, in particular for the filtration of microplastics for water-carrying household appliances.

The object is achieved by the subject matters of claims 1 and 9. The dependent claims comprise preferred embodiments.

In accordance with the invention, a filtration device is provided, in particular for the filtration of microplastics for a water-carrying household appliance, wherein the filtration device comprises a housing in which a first filter element is arranged, with the first filter element being designed in such a manner that it encloses an inner cavity which is fluidly connected to a first discharge element, with an intermediate space being present between the first filter element and the housing, into which space the water to be filtered can be introduced, with a second filter element being provided between the intermediate space and a second discharge element.

A corresponding water-conducting household appliance is in particular a washing machine. It could, of course, also be used in dishwashers. Furthermore, without limitation to the generality, a household appliance in the form of a washing machine is limited. An embodiment according to the invention achieves effective filtering of microplastic particles and fibers.

According to a particularly preferred embodiment, the housing of the filtration device extends along a height axis Z. Ideally, a supply element is provided, which is arranged along the height axis Z above the first filter element. Furthermore, it is preferred that the second filter element is arranged along the height axis Z below the first filter element. It is also beneficial that the second discharge element is arranged along the height axis Z below the second filter element.

During the pumping process, the waste water from a washing process can be fed to a filtration device. The inlet for the water to be filtered is conveniently located along the height axis Z above the first filter element and the second filter element. During the pumping process, the inserted water at least partially fills the intermediate space and passes predominantly through the first filter element in order to reach the first discharge element. The microplastic particles or fibers remain on an outer surface of the first filter element. After completion of the pumping process, a large part or almost all of the filtered microplastic particles or fibers will reach the second filter element. This takes place due to the gravitational force acting along the height axis Z. It is also an advantage that a discharge from the first discharge element is blocked when the pumping process is completed. This can preferably take place with a valve device. It is preferred that the second filter element is designed in such a manner that the microplastic particles or fibers collected therein can be easily removed.

In a further preferred embodiment, the first filter element is substantially hollow-cylindrical. The first filter element should preferably have a substantially circular cross-section. However, other differently shaped cross-sections would also be possible, for example elliptical, square, rectangular, triangular or any other polygonal shape. The first filter element should preferably have a carrier structure on which at least one filter screen is arranged. The filter screen has the advantage of forming a closed cylinder jacket. The preferred circular cross-section favors the dropping of the microplastic particles or fibers after the end of the pumping process, as this shape forms a small contact surface.

The second filter element is arranged in the housing so that it can be displaced according to a further preferred embodiment. The second filter element is preferably designed like a drawer. The second filter element is ideally removable from the housing, at least in portions. The second filter element preferably comprises at least one filter screen which is designed to be substantially planar. It is an advantage that the second filter element comprises a drawer-like carrier element in which the filter screen is arranged or integrated. Due to the advantageous possibility of removing the second filter element from the housing in a drawer-like manner, an extremely simple possibility for emptying the second filter element is provided. As the majority of the filtered microplastic particles or fibers beneficially end up in the second filter element, the entire filtration device can be emptied in a very simple manner.

According to a further preferred embodiment, a displacement system is provided by means of which the carrier element can be automatically displaced from the housing. The displacement system preferably comprises a pretensioning device, which is arranged between the carrier element and the housing. The pretensioning device can be a spring element, a pressure element or a compressible elastic element, for example. The pretensioning device serves as a drive for the displacement of the drawer-like carrier element. Furthermore, the displacement system comprises a locking device, which is provided between the carrier element and the housing. When the drawer-like carrier element is in the housing, the pretensioning device is pretensioned and the locking device prevents the carrier element from moving due to the relaxation of the pretensioning device. When the locking device is opened, the pretensioning device can relax and drive the carrier element. The locking element is preferably automatically actuated. The locking element can preferably be actuated automatically and manually. However, other embodiments of the displacement system would also be conceivable. The displacement system could thus comprise an actuating drive, for example an electrically driven actuating drive, which drives the displacement of the carrier element.

The housing of the filtration device, the carrier structure of the first filter element and the carrier element of the second filter element are preferably made of a plastic. However, an embodiment of a metal or a metal alloy would also be conceivable. The filter sieves of the first filter element and of the second filter element preferably consist of microporous and hydrophobic plastic. The filter screens can be present as solid bodies or mats. An embodiment of the filter screens as fiber fleeces would also be conceivable.

The present object of the invention is also achieved by a water-carrying household appliance comprising at least one lye container and at least one filtration device according to any of the previously described embodiments. The household appliance can be equipped with all the features already described above in the context of the filtration device, either individually or in combination with each other, and vice versa.

Such a household appliance comprises a housing in which the at least one lye container is arranged. The filtration device is preferably arranged in the housing of the household appliance. The filtration device is provided in an upper area of the household appliance in such a manner that it is easily accessible for emptying. The household appliance is preferably a washing machine. However, a dishwasher would also be conceivable. The items to be washed are placed in the lye container. During the washing process, a washing liquid in the form of water mixed with a treatment agent is then introduced into the lye container.

The water-carrying household appliance preferably comprises a pump device which conveys water from the lye container to the at least one filtration device. After or during the washing process, the waste water is pumped out of the lye container by the pumping device. The first discharge element is preferably connected to the lye container by a fluid connection. It is also possible that the first discharge element is connected to the discharge of the household appliance. The second discharge element is preferably connected to a discharge of the water-carrying household appliance via a bypass line.

Furthermore, it is advantageous that the water-carrying household appliance comprises a control device that controls the filtration device. The control device preferably controls the displacement system of the filtration device. The locking device can thereby be actuated. If the displacement system comprises an actuator, this could be controlled by the control device.

The size of the second filter element is preferably designed for a predetermined number of wash cycles.

According to a further preferred embodiment, at least one first sensor device is provided, by means of which an emptying requirement of the second filter element can be detected. At least one first sensor device is preferably connected to the control device in terms of signal technology. The control device preferably transmits an opening command to the filtration device when the emptying requirement is detected. It would also be conceivable for a signaling device of the control device to be actuated when the emptying requirement is detected. The signaling device can be an optical signaling device, for example a luminaire or an acoustic signaling device.

According to a further preferred embodiment, the first sensor device comprises at least one sensor which detects a reduced flow rate through the at least one second filter element. A sensor could possibly be provided for this purpose, by means of which the water level can be detected, preferably in the second filter element. Alternatively or cumulatively, a sensor can be provided which detects a differential pressure between the supply element and the first and/or second discharge element. Alternatively or cumulatively, a sensor can be provided which detects the flow from the second discharge element. It is preferable that when the flow rate falls below a threshold value, emptying is required and the second filter element is opened automatically. However, other sensors that can detect the need for emptying are also conceivable. For example, a desired sensor could be an optical sensor that can detect the presence of a certain amount of microplastic particles or fibers.

According to another preferred embodiment, a second sensor device is provided which detects the opening state of the second filter element. The control device preferably prevents a start of a washing program as long as the second filter element is not closed. This ensures that a washing process can only take place with corresponding filtering.

Further advantages, aims and properties of the present invention are explained with reference to the following descriptions of the attached figures. Similar components can have identical reference signs in the various embodiments.

### BRIEF DESCRIPTION OF THE DRAWINGS

Shown in the drawings:

FIG. 1 shows a lateral sectional view of a filtration device according to one embodiment;

FIG. 2 shows a sectional view of a filtration device according to one embodiment;

FIG. 3 shows a lateral sectional view of a filtration device according to one embodiment;

FIG. 4 shows a sectional view of a filtration device according to one embodiment;

FIG. 5 shows a lateral sectional view of a filtration device according to one embodiment;

FIG. 6 shows a lateral sectional view of a filtration device according to one embodiment;

FIG. 7 shows a perspective view of a filtration device according to one embodiment;

FIG. 8 shows a household appliance comprising at least one air treatment device according to one embodiment;

FIG. 9 shows a schematic diagram.

### DETAILED DESCRIPTION

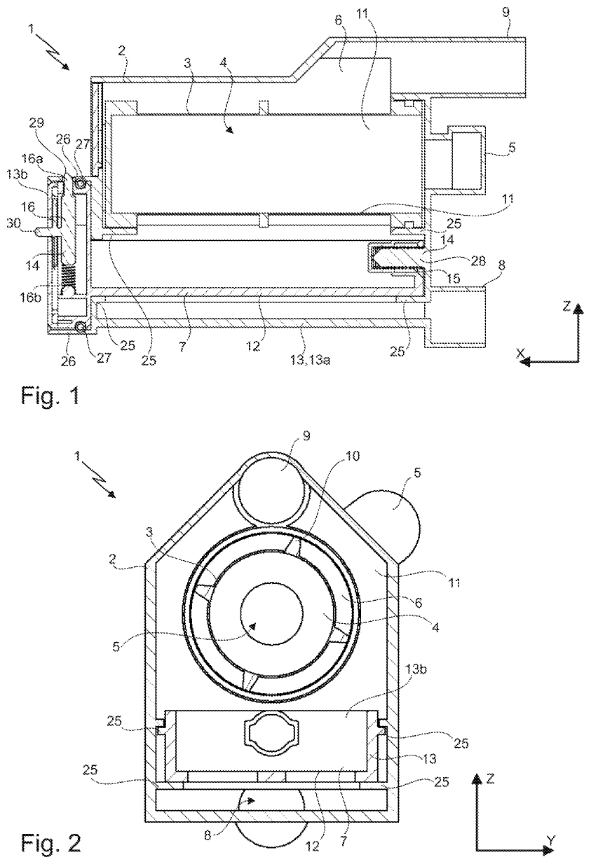

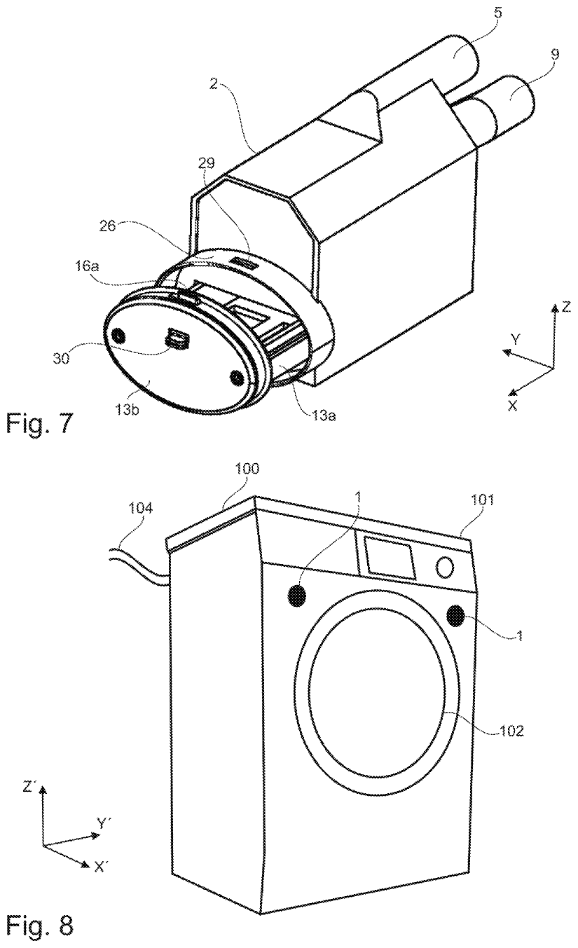

FIGS. 1 to 7 show a filtration device 1, in particular for the filtration of microplastics for a water-bearing household appliance 100. The filtration device 1 comprises a housing 2 in which a first filter element 3 is arranged, wherein the first filter element 3 is designed in such a manner that it encloses an inner cavity 4 which is fluidly connected to a first discharge element 5, wherein between the first filter element 3 and the housing 2 there is an intermediate space 6 into which the water to be filtered can be introduced, wherein a second filter element 7 is provided between the intermediate space 6 and a second discharge element 8.

The filtration device 1 extends along a height axis Z, a longitudinal axis X and a width axis Y. A household appliance 100 is shown in FIG. 8. This extends along a height axis Z′, a longitudinal axis X′ and a width axis Y′.

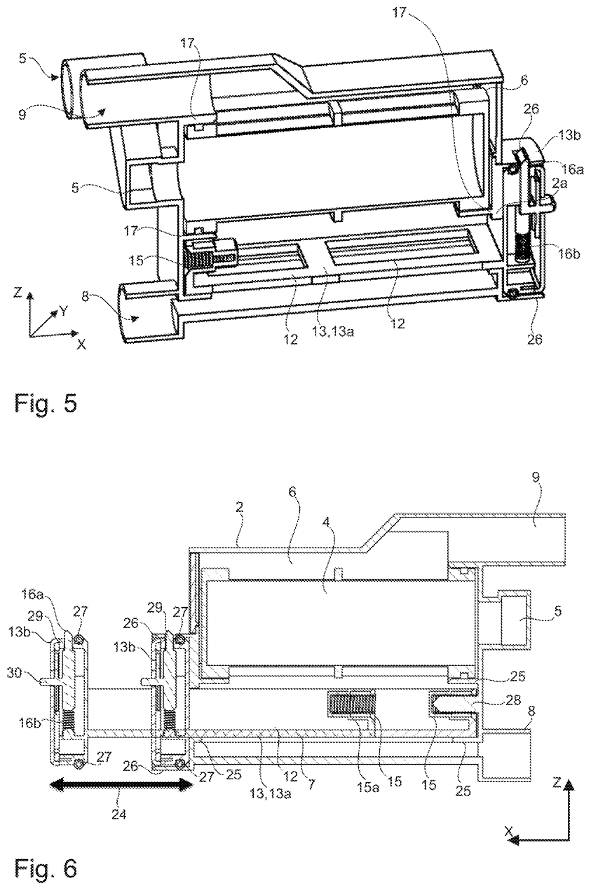

The filtration device 1 comprises a housing 2. This is substantially rectangular in shape, wherein an upper portion of the housing 2 is substantially trapezoidal. However, the design of the shape of the housing 2 is not intended to restrict the overall design. Since the filtration device 1 is arranged inside the household appliance 100, the shape of the housing 2 of the filtration device 1 can be adapted to the respective conditions of the household appliance 100. The housing 2 of the filtration device 1 extends along a height axis Z. Furthermore, a supply element 9 is provided, which is arranged along the height axis Z above the first filter element 3. The supply element 9 can be integrated in the housing 2 or arranged on it. In addition, it is capable of and intended for a supply line 9, for example in the form of a hose or pipe, to be arranged on it. This means that the first discharge element 5 is also arranged along the height axis Z below the supply element 9. The second filter element 7 is arranged along the height axis Z below the first filter element 3. Furthermore, the second discharge element 8 is arranged along the height axis Z below the second filter element 7. Both the first discharge element 5 and the second discharge element 8 can be integrated into the housing 2 or arranged thereon. These are also suitable and designed in such a manner that an outlet, for example in the form of a hose or pipe, can be arranged on them. It can be clearly seen in FIG. 5 that the first discharge element 5 first extends along the height axis Z along the housing 2. This facilitates the connection of the corresponding lines. Furthermore, the housing 2 has corresponding receiving elements 17 which serve for holding the first filter element 3.

The first filter element 3 is substantially hollow-cylindrical. According to the present embodiment shown, first filter element 3 has a substantially circular cross-section. However, other cross-sections, such as elliptical or polygonal, are also possible. The first filter element 3 has a carrier structure 10 on which at least one filter screen 11 is arranged. The inner cavity 4 is also defined by the hollow-cylindrical embodiment. The water passes into this inner cavity 4 after passing through the filter screen 11. From this cavity 4, the now filtered water enters the first discharge element 5 and then into the corresponding first discharge line. The intermediate space 6, in which the water to be filtered passes, extends around the first filter element 3.

The second filter element 7 is arranged so that it can be displaced in the housing 2. In this case, the second filter element 7 can be removed from the housing 2 at least in portions. The second filter element 7 comprises at least one filter screen 12, which is substantially of a planar design. Furthermore, the second filter element 7 comprises a carrier element 13 designed like a drawer. The filter screen 12 is arranged or integrated in this carrier element 13.

The carrier element 13 comprises a planar portion 13a in which the filter screen 12 is received or arranged. The planar portion 13a extends along the width axis Y substantially over the entire inner width of the filtration device 1. Furthermore, it can be seen in FIG. 5 that the planar portion has two recesses in which a filter screen 12 is arranged in each case. The housing 2 comprises support and guide devices 25, on which the carrier element 13 or the planar portion 13a rest and are guided accordingly when the carrier element 13 is displaced. The support and guide devices 25 are preferably designed as projections.

The carrier element 13 furthermore comprises a front portion 13b with an extension along the height axis Z. In a closed state, the front portion 13b rests against a vertical contact portion 2a of the housing 2. The housing 2 furthermore comprises projecting elements 26 extending along the longitudinal axis X. The two preforms are spaced along the height axis Z. In a closed position of the carrier element 13, the front portion 13b is arranged between the two projection elements 26. The front section 13b comprises sliding rollers 27, which rest against an inner side of the projection elements 26 or roll when the carrier element 13 is displaced. This results in a slight displacement of the front section 13b from the limiting projection elements 26.

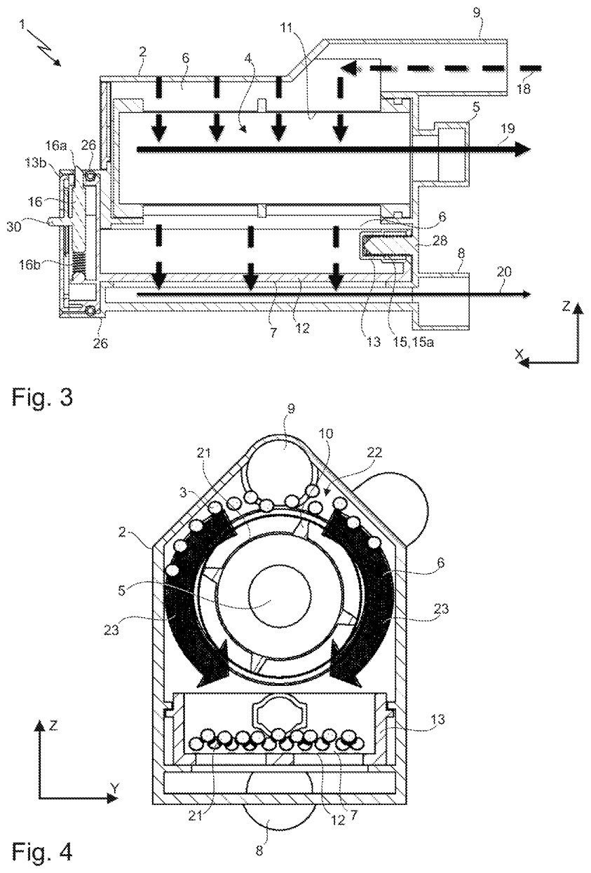

FIGS. 3 and 4 show the function of the filtration device 1. During a pumping process, the water to be filtered enters the filtration device 1 or the intermediate space 6 between the first filter element 3 and the housing 2 via the supply element 9. The water flow is illustrated with a corresponding dashed arrow 18 in FIG. 3. A large part of the water passes through the first filter element 3 and enters the inner cavity 6 filtered and then exits the filtration device 1 through the first discharge element 5. This water flow is illustrated by a corresponding arrow 19 in FIG. 3. A small amount of the water to be filtered reaches the second filter element 7 and then exits the filtration device 1 after being filtered by the second discharge element 8. This water flow is illustrated by a corresponding arrow 20 in FIG. 3. During the pumping process, the microplastic particles and fibers 21 concentrate in an area with a low flow velocity 22, which is in the upper area of the intermediate space 6. The discharge from the first discharge element 5 is preferably blocked at the end of the pumping process. For this purpose, a corresponding valve device 108 can be provided in the first discharge line. At the end of the pumping process, the microplastic particles and fibers 21 retained by the first filter element 3 then reach the second filter element 7 with the remaining water. This is illustrated by corresponding arrows 23 in FIG. 3. The inner cavity 4 also empties, since the filter screen 11 is formed circumferentially around the inner cavity 4. A majority of the microplastic particles and fibers 21 introduced finally reach the second filter element 7. The remaining water is discharged through the second filter element 7 via the second discharge element 8. Since the second filter element 7 can be removed from the housing 2, this can be easily cleaned. By cleaning the second filter element 7 accordingly, a large proportion of the microplastic particles and fibers 21 are removed from the filtration device 1. This makes it extremely easy and effective to empty the filtration device 1. The displacement of the drawer-like carrier element 13 is shown with an arrow 24 in FIG. 6.

A displacement system 14 is provided, by means of which the carrier element 13 can be automatically displaced from the housing 2. Such automatic opening of the second filter element 7 makes it easier for the user to empty the second filter element 7. The displacement system 14 can be designed in a variety of ways. In the present case, the displacement system 14 is provided with a pretensioning device 15, which is arranged between the carrier element 13 and the housing 2. In the present case, the pretensioning device 15 is a spring element 15a. In the closed state, the spring element 15a is in a tensioned state. A mandrel 28 of the housing 2 is arranged within the spring element 15a in order to secure a straight deformation of the spring element 15a.

The displacement system 14 further comprises a locking device 16 which is provided between the carrier element 13 and the housing 2. The locking device 16 is arranged in the front section 13b of the carrier element 13 and comprises a latch 16a, which is subjected to a spring force by means of a spring element 16b. As a result of the spring force application, the bolt 16a is pressed upwards along the height axis Z. In a closed position of the carrier element 13, an upper portion of the latch 16a is provided within a recess 29, which is in the upper one of the projection elements 26. The carrier element 13 is held in position by this engagement of the latch 16a. The latch 16a also has a bevel. When transferring the carrier element 13 from an open position to a closed position, the latch 16a contacts a front surface of the upper projection element 26. The bevel causes the latch 16a to slide against the front surface of the upper projection element 26 and the latch 16a is pressed downwards against the spring force. As soon as the latch 16a has reached the recess 29, it is displaced into the recess 29 by the spring force. A handle element 30 is furthermore arranged on the bolt 16a. This handle element 30 extends along the longitudinal axis X beyond the front portion 13b of the carrier element 13. By means of this handle element 30, a user can open the lock manually.

The locking device 16 further comprises a drive device which drives a movement of the latch 16a so that it is displaced from the recess 29. This drive device is controlled by a control device 105 of the household appliance 100. The drive device can be an actuator, for example, which is operatively connected to the latch 16a. This can be done using a Bowden cable or other transmission device, for example.

FIG. 8 shows a household appliance 100 in the form of a washing machine. The household appliance 100 comprises a housing 101 and a lye container 102 provided within. The housing 101 comprises a front side, which comprises a closure device for the lye container 102, a display and control panel and a detergent drawer. The filtration device 1 is provided in an upper area of a front side of the housing 101 and is therefore easily accessible to a user. Possible arrangements are shown in FIG. 8. The household appliance 100 preferably comprises only one filtration device 1.

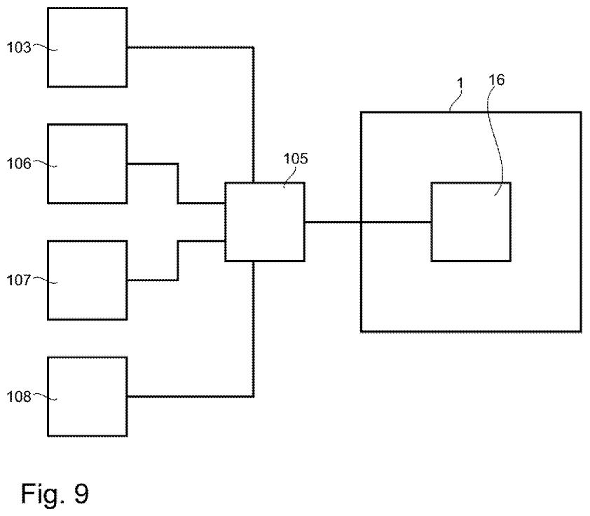

The water-carrying household appliance 100 comprises a control device 105, which controls the filtration device 1, among other things. Furthermore, the water-carrying household appliance 100 comprises a pumping device 103 which conveys water from the lye container 102 to the at least one filtration device 1. A supply line, which is connected to the supply element 9, is provided for this purpose. The filtered water can also be discharged from the first discharge element 5 by means of the pump device 103. The control device 105 also controls the pump device 103, as shown in the schematic diagram in FIG. 9.

The first discharge element 5 is also connected to the discharge 104 of the water-carrying household appliance 100 and/or the lye container 102 by means of a first drain line. A valve device 108 can be provided in this first outlet, which is controlled by the control device 105 in such a way that the valve device 108 is open during the pumping process and the valve device 108 is closed when the pumping process ends. The second discharge element 8 is connected to a discharge 104 of the water-carrying household appliance 100 via a bypass line. It is conceivable that an additional pump device is provided in the second discharge element 8 and/or in the bypass line, by means of which the water can be pumped out of the second discharge element 8 or the filtration device 1. According to this idea, it would not be necessary to provide a valve device. During the pumping process of the pumping device 103, the additional pumping device is not activated, so that no water can be discharged via the second discharge element 8. The filtered water is therefore advantageously only discharged via the first discharge element 5 during the pumping process. After the pumping process of the pumping device 103 is completed, the additional pumping device is activated. As a result, the filtered water can advantageously only be drained off via the second discharge element 8 after the pumping process is complete, as it no longer flows off via the first discharge element 5.

Furthermore, at least one first sensor device 106 is provided, by means of which an emptying requirement of the second filter element 7 can be detected. This first sensor device 106 can be designed in a variety of ways, for example a flow sensor can be provided, which detects the flow through the second discharge element 8 and/or the associated discharge. An optical sensor that detects a predetermined quantity of microplastic particles and fibers 21 in the second filter element 7 would also be conceivable. When the emptying requirement is detected, the control device 105 transmits an opening command to the filtration device 1, i.e., the locking device 16, in particular the corresponding drive device, is activated so that the carrier device 13 is unlocked and, driven by the pretensioning device 15, is moved from the closed position to the open position. This is shown in FIG. 6 on the basis of arrow 24. The automatic opening informs the user that the filtration device 1 needs to be emptied. It would also be possible to provide an additional visual or acoustic warning device to inform the user of the need to empty the container.

A second sensor device 107 can be provided, which detects the opening state of the second filter element 7. This sensor device 107 is connected to the control device 105 via a signal. The control device 105 prevents the start of a wash program as long as the second filter element 7 is not closed. This ensures that no washing process can take place with an open second filter element 7.

The filtration device 1 achieves effective filtration of microplastic particles and fibers 21. Furthermore, the simple cleaning option of the filtration device 1 eliminates the need for time-consuming replacement of microplastic filters.

The applicant reserves the right to claim all features disclosed in the application documents as essential to the invention, provided that they are new, either individually or in combination, compared to the prior art. It should also be noted that the individual figures also describe features which may be advantageous in themselves. The skilled person will immediately recognize that a certain feature described in a figure can also be advantageous without the adoption of further features from this figure. Furthermore, the skilled person will recognize that advantages can also result from a combination of several features shown in individual figures or in different figures.

### LIST OF REFERENCE SIGNS

1 Filtration device
2 Housing
2a Contact portion of the housing
3 First filter element
4 Inner cavity of the first filter element
5 First discharge element
6 Intermediate space
7 Second filter element
8 Second discharge element
9 Supply element
10 Carrier structure
11 Filter screen
12 Filter screen
13 Carrier element
13a Planar portion
13b Front portion
14 Displacement system
15 Pretensioning device
15a Spring element
16 Locking device
16a Latch
16b Spring element
17 Receiving element
18 Arrow
19 Arrow
20 Arrow
21 Microplastic particles and fibers
22 Area with a low flow velocity
23 Arrow
24 Arrow
25 Support and guide devices
26 Projection elements
27 Sliding rollers
28 Mandrel element
29 Recess
30 Handle element
100 Household appliance
101 Housing
102 Lye container
103 Pump device
104 Discharge of the household appliance
105 Control device
106 First sensor device
107 Second sensor device
108 Valve device
X Longitudinal axis of the filtration device
Y Width axis of the filtration device
Z Height axis of the filtration device
X′ Longitudinal axis of the household appliance
Y′ Width axis of the household appliance
Z′ Height axis of the household appliance

What is claimed is:

1. A filtration device for filtration of microplastics for a water-carrying household appliance, wherein the filtration device comprises a housing in which a first filter element is arranged, wherein the first filter element is configured to enclose an inner cavity which is fluidly connected to a first drain element, wherein an intermediate space is provided between the first filter element and the housing, into which intermediate space water to be filtered can be introduced, and wherein a second filter element is provided between the intermediate space and a second drain element.

2. The filtration device according to claim 1, wherein the housing of the filtration device extends along a height axis Z, wherein a supply element is provided which is arranged along the height axis Z above the first filter element, wherein the second filter element is arranged along the height axis Z below the first filter element, and wherein a second discharge element is arranged along the height axis Z below the second filter element.

3. The filtration device according to claim 1, wherein the first filter element is of substantially hollow-cylindrical shape, has a substantially circular cross-section, and has a carrier structure on which at least one filter screen is arranged.

4. The filtration device according to claim 1, wherein the second filter element is arranged displaceably in the housing, wherein the second filter element can be removed from the housing at least in portions, wherein the second filter element comprises at least one filter screen which is substantially planar, and wherein the second filter element comprises a drawer-like carrier element, in which the at least one filter screen is arranged or integrated.

5. The filtration device according to claim 3, wherein a displacement system is provided, by means of which the carrier element can be automatically displaced out of the housing, wherein the displacement system comprises a pretensioning device which is arranged between the carrier element and the housing, wherein the displacement system further comprises a locking device provided which is provided between the carrier element and the housing, and wherein the locking device can be automatically actuated.

6. A water-carrying household appliance comprising:
a housing;
at least one lye container arranged in the housing; and
at least one filtration device according to claim 1, arranged in the housing.

7. The water-carrying household appliance according to claim 6, wherein the water-carrying household appliance further comprises a pump device which conveys water from the at least one lye container to the at least one filtration device, wherein the first drain element is fluidly connected to the at least one lye container, and wherein the second drain element is connected via a bypass line to a discharge of the water-carrying household appliance.

8. The water-carrying household appliance according to claim 6, wherein the water-carrying household appliance further comprises a control device which controls the at least one filtration device, wherein at least one first sensor device is provided, by means of which an emptying requirement of the second filter element can be detected, and wherein the control device is configured to transmit an opening command to the filtration device upon detection of the emptying requirement.

9. The water-carrying household appliance according to claim 8, wherein the at least one first sensor device comprises at least one sensor which detects a reduced flow rate through the second filter element, and wherein the emptying requirement is present when the flow rate falls below a threshold value.

10. The water-carrying household appliance according to claim 8, wherein a second sensor device is provided, which detects an opening state of the second filter element, wherein the control device prevents a start of a washing program as long as the second filter element is not closed.
